(19) United States
(12) Patent Application Publication
(10) Pub. No.: US 2026/0036674 A1
(43) Pub. Date: Feb. 5, 2026

(54) GAIN AND PHASE IMBALANCE ESTIMATION USING A LEAST MEAN SQUARES TECHNIQUE

(71) Applicant: Infineon Technologies AG, Neubiberg (DE)

(72) Inventors: Esmaeil KAVOUSI GHAFI, Linz (AT); Alexander MELZER, Alberndorf in der Riedmark (AT); Matthias WAGNER, Engerwitzdorf (AT); Oliver LANG, Natternbach (AT)

(21) Appl. No.: 18/789,414

(22) Filed: Jul. 30, 2024

(51) Int. Cl. G01S 7/40; G01S 13/58

(52) U.S. Cl. CPC G01S 7/40; G01S 7/4008; G01S 7/4021; G01S 13/584

(57) ABSTRACT

A radar device may identify a peak in an integrated range-velocity map. The peak may indicate one or more targets in the integrated range-velocity map and being associated with a range-velocity bin index. The radar device may extract, based on the range-velocity bin index associated with the peak, an actual signal vector from a plurality of range-velocity maps. Each range-velocity map in the plurality of range-velocity maps may correspond to a respective radar channel from a plurality of radar channels. The radar device may determine an estimated target signal vector based on the actual signal vector and a first estimated imbalance vector. The radar device may determine a second estimated imbalance vector based on the actual signal vector, the estimated target signal vector, and an error vector. The radar device may perform an action, associated with the plurality of radar channels, based on the second estimated imbalance vector.

### BACKGROUND

Radar sensors are used in a number of applications to detect objects, where the detection typically comprises measuring distances, velocities, or angles of arrival of detected targets. In particular, in the automotive sector, there is an increasing need for radar sensors that are able to be used in, for example, driving assistance systems (e.g., advanced driver assistance systems (ADAS)) such as, for example, adaptive cruise control (ACC) or radar cruise control systems. Such systems are automatically able to adjust the speed of a motor vehicle in order to maintain a safe distance from other motor vehicles traveling in front of the motor vehicle (and from other objects and from pedestrians). Other example applications of a radar sensor in the automotive sector include blind spot detection, lane change assist, and the like.

### SUMMARY

In some implementations, a radar device includes one or more memories; and one or more processors, communicatively coupled to the one or more memories, configured to: identify a peak in an integrated range-velocity map, the peak indicating one or more targets in the integrated range-velocity map and being associated with a range-velocity bin index; extract, based on the range-velocity bin index associated with the peak, an actual signal vector from a plurality of range-velocity maps, wherein each range-velocity map in the plurality of range-velocity maps corresponds to a respective radar channel from a plurality of radar channels; determine an estimated target signal vector based on the actual signal vector and a first estimated imbalance vector; determine a second estimated imbalance vector based on the actual signal vector, the estimated target signal vector, and an error vector; and perform an action, associated with the plurality of radar channels, based on the second estimated imbalance vector.

In some implementations, a method includes identifying a peak in an integrated range-velocity map, the peak indicating one or more targets in the integrated range-velocity map and being associated with a range-velocity bin index; extracting, based on the range-velocity bin index associated with the peak, an actual signal vector from a plurality of range-velocity maps, wherein each range-velocity map in the plurality of range-velocity maps corresponds to a respective radar channel from a plurality of radar channels; computing an estimated target signal vector based on the actual signal vector and a first iteration of an estimated imbalance vector; computing a second iteration of an estimated imbalance vector based on the actual signal vector, the estimated target signal vector, and an error vector; and performing an action, associated with the plurality of radar channels, based on the second iteration of the estimated imbalance vector.

In some implementations, a radar device includes one or more memories; and one or more processors, communicatively coupled to the one or more memories, configured to: compute an estimated target signal vector based on an actual signal vector and a first estimate of an imbalance vector associated with a plurality of radar channels; compute a second estimate of the imbalance vector based on the actual signal vector, the estimated target signal vector, and an error vector; and perform an action based on the second estimate of the imbalance vector, wherein the action is associated with at least one of phase imbalance calibration for the plurality of radar channels or fatigue detection from the plurality of radar channels.

### BRIEF DESCRIPTION OF THE DRAWINGS

FIG. 1 is a diagram of an example application of a frequency-modulated continuous-wave (FMCW) radar sensor.

FIG. 2 illustrates an example of frequency modulation of a transmitted radar signal transmitted by a radar sensor.

FIG. 3 is a block diagram that illustrates an example structure of a radar sensor.

FIG. 4 illustrates an example implementation of the radar sensor according to the example from FIG. 3.

FIGS. 5A-5C illustrates an example of signal processing performed by a radar sensor.

FIGS. 6A-6C are diagrams illustrating examples associated with performing phase imbalance detection in a radar sensor using a least mean squares (LMS) technique.

FIGS. 7A-7C are diagrams associated with an example implementation of performing phase imbalance detection using an LMS technique.

FIG. 8 is a flowchart of an example process associated with phase imbalance estimation using an LMS technique.

### DETAILED DESCRIPTION

The following detailed description of example implementations refers to the accompanying drawings. The same reference numbers in different drawings may identify the same or similar elements.

In a radar sensor, gain and phase imbalances among radar channels of a monolithic microwave integrated circuit (MMIC) can occur due to, for example, temperature variations, voltage variations, or hardware fatigue. As one example, components of the MMIC may be connected to a printed circuit board (PCB) by a set of solder balls. During a lifetime of the radar sensor, a solder ball may deteriorate or break, which causes a connection between the MMIC and the PCB to be broken or degraded. Such a break, referred to as a ball break, can cause phase deviation or attenuation of a signal transmitted by the radar sensor (e.g., when the ball break is on a connection of a transmit (TX) antenna) and/or a signal received by the radar sensor (e.g., when the ball break is on a connection of a receive (RX) antenna).

Some processing steps, such as angle of arrival (AoA) estimation of a target of the radar sensor, rely on a phase and gain balance of the received radar signal in order to achieve reliable performance. Thus, gain and phase imbalance among radar channels of the radar sensor can significantly reduce performance of the radar sensor. Therefore, detection and calibration of a gain or phase imbalance (e.g., caused by a ball break) is a critical safety task to ensure safe and reliable operation of the radar sensor.

One technique that provides for phase and gain imbalance estimation among radar channels requires isolated targets in a field of view of the radar system in order to detect the phase and gain imbalance. However, in practice, multiple targets often exist in the field of view of the radar sensor. As a result, this technique suffers from a slow update rate in scenarios with infrequent occurrences of single targets. Therefore, this technique is not suitable for an application in which fast failure detection is required, such as ball break detection.

Another technique that provides for phase imbalance estimation with respect to RX channels of a radar sensor requires TX channels of the radar sensor to be calibrated. The calibration of the TX channels therefore complicates phase and gain imbalance detection as performed by the radar sensor. Further, this technique requires single targets in a given processed range-Doppler bin. This causes the technique to suffer from a slow update rate in scenarios with infrequent occurrences of single targets, meaning that this technique is not suitable for an application in which fast detection is required (e.g., ball break detection).

A conventional technique for performing ball break detection specifically (as compared to gain and phase imbalance generally) is a hardware-based technique according to which ball break detection is performed by measuring a direct current (DC) resistance to ground at an input pad of the radar sensor. However, while such a technique provides ball break detection, implementation of the technique in a complementary metal-oxide-semiconductor (CMOS)-based radar sensor causes significant noise figure degradation, which negatively impacts accuracy and reliability of the radar sensor and, therefore, is undesirable. Another technique for performing ball break detection is a hardware-based technique according to which impedance of an antenna (and ball) is measured using a matching circuit and a test signal. Here, if the measured impedance is higher than an impedance threshold, then a ball break is detected. However, while such a technique provides ball break detection, an area on the MMIC needed to implement this technique is significant and, therefore, such a technique may be undesirable (e.g., when an available area on the MMIC is limited).

Some implementations described herein enable phase imbalance detection in a radar sensor (e.g., a frequency-modulated continuous-wave (FMCW) radar sensor). In some aspects, a radar device (e.g., an FMCW radar sensor) may identify a peak in an integrated range-velocity map, with the peak indicating one or more targets in the integrated range-velocity map and being associated with a range-velocity bin index. The radar device may extract, based on the range-velocity bin index associated with the peak, an actual signal vector from a plurality of range-velocity maps. Here, each range-velocity map in the plurality of range-velocity maps corresponds to a respective radar channel from a plurality of radar channels. The radar device may then determine an estimated target signal vector based on the actual signal vector and a first estimated imbalance vector. The radar device may then determine a second estimated imbalance vector based on the actual signal vector, the estimated target signal vector, and an error vector, and may perform an action, associated with the plurality of radar channels, based on the second estimated imbalance vector.

The techniques and apparatuses described herein utilize a signal processing approach for gain and phase imbalance detection, meaning that these techniques can be implemented on a controller of the radar device (e.g., rather than requiring additional MMIC circuitry). Another advantage is that the techniques and apparatuses described herein require low computational complexity because most of the required computation already needs to be performed for normal operation of the radar device. Another advantage is that, although ball break detection is provided by the techniques and apparatuses described herein, the techniques and apparatuses described herein can also be utilized more generally for (e.g., real-time) gain and phase imbalance detection and calibration (e.g., to detect and/or calibrate a gain or phase imbalance with a cause other than a ball break).

Further, as compared to the techniques for gain and phase imbalance detection noted above, the techniques and apparatuses described herein are not restricted to single targets and, therefore, can be used even when multiple targets are in a processed range-Doppler bin. As a result, the techniques and apparatuses described herein provide a faster update rate of channel imbalance estimations, which is crucial for some applications, such as ball break detection. Additional details are provided below.

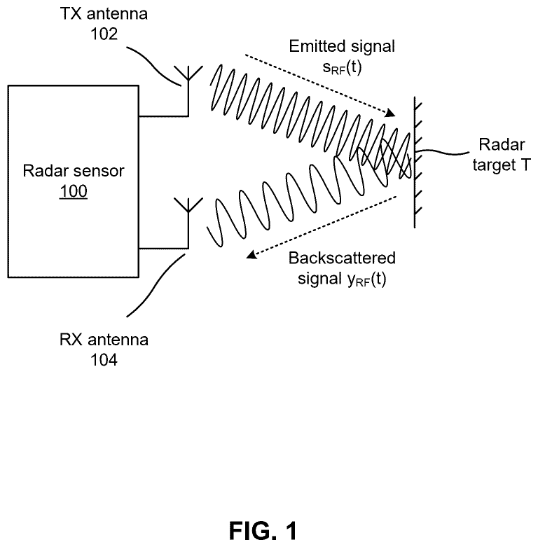

FIG. 1 is a diagram illustrating an example application of a FMCW radar sensor in the form of a radar sensor 100 for measuring distances, velocities, or AoAs of objects, referred to as targets. As shown in FIG. 1, the radar sensor 100 may have one or more TX antennas 102 and one or more RX antennas 104. In some implementations, a single antenna may be used that serves simultaneously as a TX antenna 102 and as an RX antenna 104. In operation, the TX antenna 102 emits a radio frequency (RF) signal s_{RF}(t) (herein referred to as a transmitted radar signal), which is frequency-modulated with, for example, a type of sawtooth signal (e.g., a periodic linear frequency ramp). The transmitted radar signal s_{RF}(t) is backscattered at a target T and a backscattered/reflected signal y_{RF}(t) (i.e., an echo signal, also referred to herein as a received radar signal) is received by the RX antenna 104. FIG. 1 shows a simplified example—in practice, the radar sensor 100 may include a plurality of TX antennas 102 and RX antennas 104 to be able to determine an AoA of the received radar signal y_{RF}(t) and, therefore, locate the target T with increased accuracy.

As indicated above, FIG. 1 is provided as an example. Other examples may differ from what is described with regard to FIG. 1.

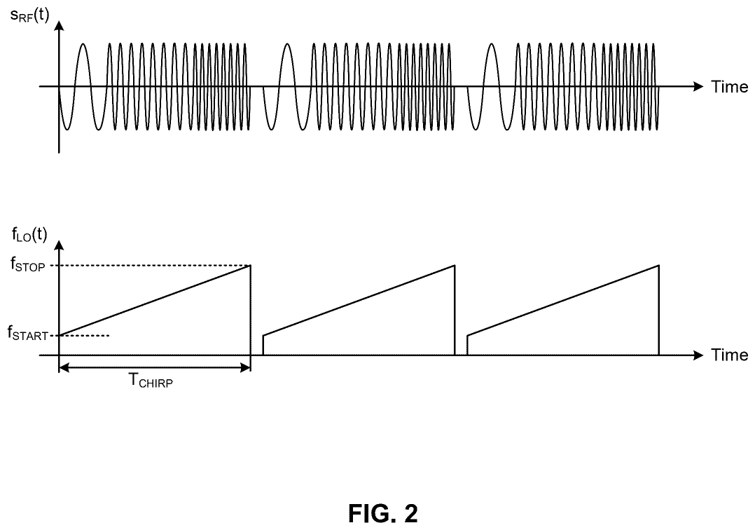

FIG. 2 illustrates an example of the frequency modulation of the transmitted radar signal s_{RF}(t). As illustrated in the upper diagram of FIG. 2, the transmitted radar signal s_{RF}(t) comprises a series of “chirps”; that is to say the transmitted radar signal s_{RF}(t) comprises a sequence of sinusoidal signal profiles (i.e., waveforms) with a rising frequency (referred to as an up-chirp) or a falling frequency (referred to as a down-chirp). In the example shown in FIG. 2, the instantaneous frequency f_{LO}(t) of a chirp increases linearly, starting at a start frequency f_{START}, to a stop frequency f_{STOP} within a time interval T_{CHIRP}, as shown in the lower diagram of FIG. 2. Such chirps are also referred to as linear frequency ramps. FIG. 2 illustrates three identical linear frequency ramps; however, the parameters f_{START}, f_{STOP}, or T_{CHIRP} and a pause between individual frequency ramps may be varied. Further, the frequency variation need not be linear. Depending on the implementation, transmitted radar signals with exponential or hyperbolic frequency variation (e.g., exponential chirps or hyperbolic chirps) may be used, for example. For a measurement, a sequence of frequency ramps is emitted, and a resulting echo signal is evaluated in baseband to detect one or more radar targets.

As indicated above, FIG. 2 is provided as an example. Other examples may differ from what is described with regard to FIG. 2.

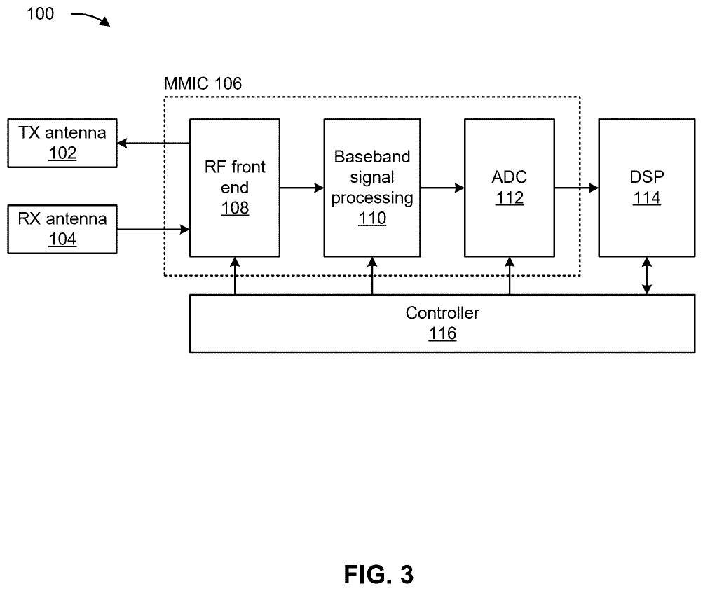

FIG. 3 is a block diagram that illustrates an example structure of the radar sensor 100. As shown, the radar sensor 100 may include one or more TX antennas 102, one or more RX antennas 104, an MMIC 106 (comprising an RF front end 108, a baseband signal processing component 110, and an analog-to-digital convertor (ADC) 112), a digital signal processor (DSP) 114, and a controller 116.

In the radar sensor 100, the one or more TX antennas 102 and the one or more RX antennas 104 are connected to the RF front end 108. The RF front end 108 may include circuit components associated with performing RF signal processing. These circuit components may include, for example, a local oscillator (LO), one or more RF power amplifiers, one or more low noise amplifiers (LNA), one or more directional couplers (e.g., rat-race couplers, circulators, or the like), or one or more mixers for downmixing (or down-converting) RF signals into baseband or an intermediate frequency band (IF band). As shown, the RF front end 108 may be integrated into the MMIC 106 with one or more other components. The IF band is sometimes also referred to as baseband. No further distinction is drawn herein between baseband and IF band, and only the term baseband is used herein. Baseband signals are those signals on the basis of which radar targets are detected.

The example illustrated in FIG. 3 shows a bistatic (or pseudo-monostatic) radar system with a separate RX antenna 104 and TX antenna 102. In a monostatic radar sensor 100, the same antenna could be used both to emit and to receive radar signals. In such an implementation, a directional coupler (e.g., a circulator) may be used to separate RF signals to be emitted from received radar signals.

In some implementations, the radar sensor 100 may include a plurality of TX antennas 102 and a plurality of RX antennas 104, which enables the radar sensor 100 to measure an AoA from which radar echoes are received. In the case of such multiple-input multiple-output (MIMO) systems, individual TX channels and RX channels may be constructed identically or similarly and may be distributed over one or more MMICs 106.

In some implementations, a signal emitted by the TX antenna 102 may be in a range from approximately 20 gigahertz (GHz) to approximately 100 GHz, such as in a range between of approximately 76 GHz and approximately 81 GHz. As mentioned, a radar signal received by the RX antenna 104 includes radar echoes (e.g., chirp echo signals); that is to say those signal components that are backscattered at one or more targets. The received radar signal y_{RF}(t) is downmixed into, for example, baseband and processed further in baseband by way of analog signal processing performed by the baseband signal processing component 110. In some implementations, the baseband signal processing component 110 may be configured to filter and/or amplify the baseband signal. The ADC 112 may be configured to digitize the baseband signal. The DSP 114 may be configured to further process the digitized baseband signal in the digital domain. In some implementations, the controller 116 is configured to control operation of the radar sensor 100 (e.g., by controlling one or more other components of the radar sensor 100, as indicated in FIG. 3). The controller 116 may include, for example, a microcontroller (μC).

In some implementations, the RF front end 108, the baseband signal processing component 110, the ADC 112, and/or the DSP 114 may be integrated in a single MMIC 106 (e.g., an RF semiconductor chip). Alternatively, two or more of these components may be distributed over multiple MMICs 106. In some implementations, the DSP 114 may be included in the controller 116. In some implementations, the techniques associated with detection of a gain and phase imbalance using an LMS technique as described herein may be performed by one or more components of the radar sensor 100, such as by the DSP 114, the controller 116, or the like.

As indicated above, FIG. 3 is provided as an example. Other examples may differ from what is described with regard to FIG. 3. The number and arrangement of devices and components shown in FIG. 3 are provided as an example. In practice, there may be additional devices or components, fewer devices or components, different devices or components, or differently arranged devices or components than those shown in FIG. 3. Furthermore, two or more devices or components shown in FIG. 3 may be implemented within a single device or component, or a single device or component shown in FIG. 3 may be implemented as multiple, distributed devices or components. Additionally, or alternatively, a set of devices or components (e.g., one or more devices or components) shown in FIG. 3 may perform one or more functions described as being performed by another set of devices or components shown in FIG. 3.

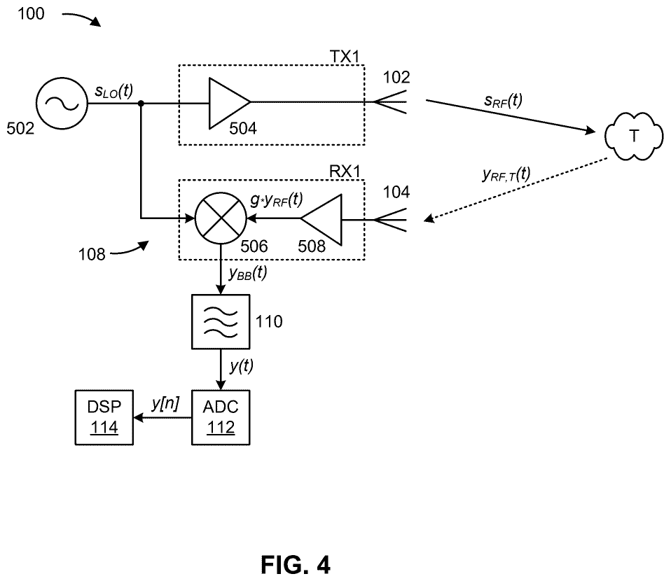

FIG. 4 illustrates an example implementation of a radar sensor 100 according to the example from FIG. 3. The example shown in FIG. 4 illustrates an example of the RF front end 108 of the radar sensor 100. FIG. 4 illustrates a simplified circuit diagram to show a fundamental structure of the RF front end 108 with one TX channel and one RX channel. As noted above, the radar sensor 100 may in practice include a plurality of TX channels and/or a plurality of RX channels.

As shown, the RF front end 108 comprises a local oscillator (LO) 502 that generates an RF oscillator signal s_{LO}(t). During operation—as described above with reference to FIG. 2—the RF oscillator signal s_{LO}(t) is frequency-modulated and may be referred to as an LO signal. In radar applications, the LO signal may be in a super high frequency (SHF) band (i.e., centimeter wave) or in an extremely high frequency (EHF) band (i.e., millimeter wave), for example, in a range between approximately 76 GHz and approximately 81 GHz. The LO signal s_{LO}(t) is processed both in the transmitted radar signal path TX1 (in the TX channel) and in the received radar signal path RX1 (in the RX channel).

The transmitted radar signal s_{RF}(t) emitted by the TX antenna 102 is generated by amplifying the LO signal s_{LO}(t), for example by an RF power amplifier 504 and, therefore, is an amplified and (possibly) phase-shifted version of the LO signal s_{LO}(t). The output of the amplifier 504 may be coupled to the TX antenna 102 (e.g., in a bistatic or pseudo-monostatic radar configuration). As shown, the transmitted radar signal is backscattered/reflected by a target T, and a resulting RF signal y_{RF}(t) is received at the RX antenna 104.

The received radar signal y_{RF}(t) received by the RX antenna 104 is provided to a receiver circuit in the RX channel and, therefore, directly or indirectly to an RF port of the mixer 506. In the example shown in FIG. 4, the received radar signal y_{RF}(t) is pre-amplified by an amplifier 508 (e.g., using an amplification factor g). The mixer 506 therefore in some implementations receives an amplified received radar signal g·y_{RF}(t). The amplifier 508 may be, for example, an LNA. As further shown, the LO signal s_{LO}(t) is provided to a reference port of the mixer 506, and the mixer 506 downmixes the (pre-amplified) received radar signal y_{RF}(t) into baseband. The downmixed baseband signal (i.e., a mixer output signal) is referred to as baseband signal y_{BB}(t). This baseband signal y_{BB}(t) is processed in the analog domain by the baseband signal processing component 110, which may perform, for example, amplification and filtering (e.g., band-pass filtering, low-pass filtering, or the like) to suppress undesired sidebands or mirror frequencies. A resulting analog output signal provided to ADC 112 is referred to as analog signal y(t). The ADC 112 digitizes the analog signal y(t) to generate a digitize signal y[n]. The DSP 114 may then further process the digitized signal y[n]. For example, the DSP 114 may perform a range-velocity analysis or phase imbalance detection, as described in further detail below.

In some implementations, the mixer 506 downmixes the pre-amplified received radar signal g·y_{RF}(t) into baseband. In some implementations, the mixing may be performed in one stage (i.e., from the RF band directly into baseband) or over one or more intermediate stages (i.e., from the RF band into an intermediate frequency band and further into baseband). In the latter case, the mixer 506 may comprise a plurality of individual mixer stages connected in series. In some implementations, an in-phase and quadrature (IQ) mixer may be used to generate complex baseband signals (e.g., including in-phase and quadrature components). Further, with respect to the example shown in FIG. 4, a quality of a radar measurement depends on a quality of the LO signal s_{LO}(t), for example on an amount of noise included in the LO signal s_{LO}(t), which is determined in terms of quantity by the phase noise of the LO 502.

As indicated above, FIG. 4 is provided as an example. Other examples may differ from what is described with regard to FIG. 4. The number and arrangement of devices and components shown in FIG. 4 are provided as an example. In practice, there may be additional devices or components, fewer devices or components, different devices or components, or differently arranged devices or components than those shown in FIG. 4. Furthermore, two or more devices or components shown in FIG. 4 may be implemented within a single device or component, or a single device or component shown in FIG. 4 may be implemented as multiple, distributed devices or components. Additionally, or alternatively, a set of devices or components (e.g., one or more devices or components) shown in FIG. 4 may perform one or more functions described as being performed by another set of devices or components shown in FIG. 4.

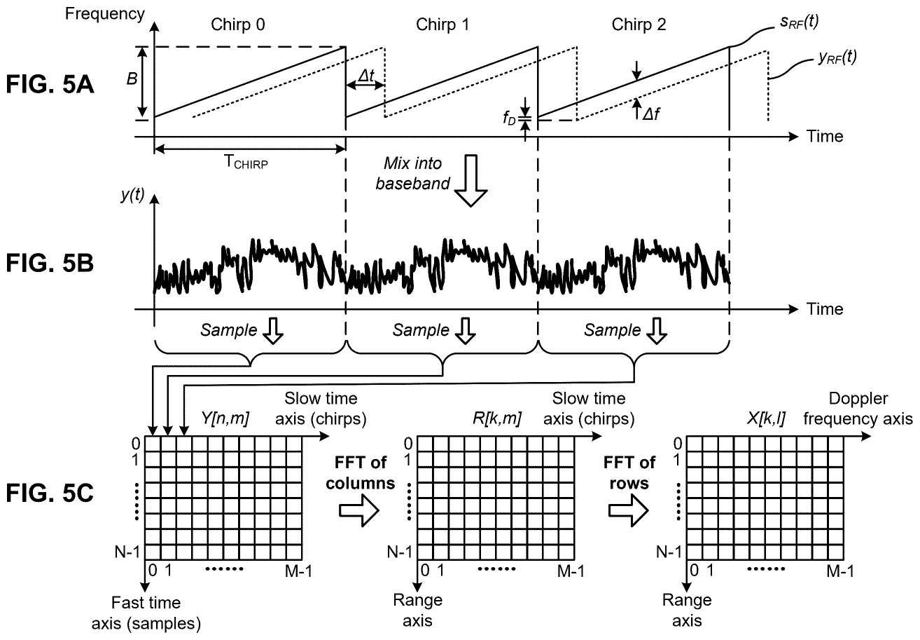

FIGS. 5A-5C illustrates an example of signal processing performed by the radar sensor 100. FIG. 5A illustrates a portion of a chirp sequence that comprises M linear chirps. The solid line represents a signal profile (e.g., waveform, frequency over time) of a transmitted radar signal s_{RF}(t), and the dashed line represents a corresponding signal profile of a received (and possibly pre-amplified) signal y_{RF}(t) that (when present) includes chirp echoes. In the example shown by FIG. 5A, a frequency of the transmitted radar signal s_{RF}(t) increases linearly, starting at a start frequency f_{START}, to a stop frequency f_{STOP} (e.g., for chirp 0), and then returns to the start frequency f_{START}, increases to the stop frequency f_{STOP} (e.g., for chirp 1), and so on.

Depending on the application, a chirp sequence may include one or more chirps with different parameters (e.g., a different start frequency, a different stop frequency, or the like). For example, during a modulation pause between two successive chirps, the frequency may be the same as the stop frequency of the previous chirp or the start frequency of the following chirp. The chirp duration may be in the range from, for example, a few microseconds (μs) to a few milliseconds (ms), for example in a range from approximately 20 us to approximately 2 ms. The number M of chirps in a chirp sequence may correspond to a power of two, for example the chirp sequence may include 256 chirps (M=256).

As shown in FIG. 5A, the received radar signal y_{RF}(t) (e.g., received by an RX antenna 104) lags the transmitted radar signal s_{RF}(t) (e.g., emitted by one or more TX antennas 102) by a time difference Δt. The time difference Δt corresponds to a signal propagation time from the one or more TX antennas 102 to a target and back to the RX antennas 104. The signal propagation time may also be referred to as a round trip delay time (RTDT). A distance d_{T}_{ᵢ} of a target Tᵢ from the radar sensor 100 is equal to the speed of light c times half the time difference Δt (i.e., d_{T}_{ᵢ}=c·Δt/2). As can be seen in FIG. 5A, the time difference Δt results in a corresponding frequency difference Δf at a given point in time. This frequency difference Δf may be determined by mixing the received radar signal y_{RF}(t) with the LO signal s_{LO}(t) of the radar sensor 100, digitizing a resulting baseband signal y(t), and then performing digital spectral analysis. The frequency difference Δf appears in the spectrum of the digitized baseband signal y[n] as a beat frequency. If linear chirps are used, then the time difference Δt may be calculated according to Δt=Δf/k, where the factor k is a gradient (hertz per second) of the frequency ramp that can be calculated according to k=B/T_{CHIRP}, where B is a bandwidth of a chirp (B=|f_{STOP}−f_{START}|). The distance d_{T}_{ᵢ} of the target Tᵢ can therefore be determined using the following equation:

$${d}_{{T}_{i}} = c \cdot Δ t / 2 = c \cdot Δ f \cdot {T}_{CHIRP} / ( 2 B )$$

In some implementations, additional signal processing can be performed in addition to the basic functional principle of the radar sensor 100 described above. For example, an additional Doppler shift f_{D} of the received radar signal (e.g., a frequency shift caused by the Doppler effect) may influence the distance measurement by adding the Doppler shift f_{D} to the frequency difference Δf. In some applications, the Doppler shift may be estimated from the transmitted radar signal s_{RF}(t) and the received radar signal y_{RF}(t) and may be considered in the distance measurement, whereas the Doppler shift may be negligible for the distance measurement in some other applications. The Doppler shift may have a negligible effect when, for example, a chirp duration is relatively high and a velocity of the target is relatively low (e.g., such that the frequency difference Δf is large in comparison with the Doppler shift f_{D}). In some implementations, the Doppler shift may be eliminated by determining the distance based on an up-chirp and a down-chirp in the distance measurement. Here, the distance d_{T} may be calculated as the average of distance values obtained from a measurement using up-chirps and a measurement using down-chirps. Thus, the Doppler shift may in some implementations be eliminated through averaging.

One example of a signal processing technique for processing FMCW signals involves calculating so-called range-velocity maps (also referred to as range-Doppler maps or range-Doppler images). In general, as described above, the radar sensor 100 may determine information associated with a target (e.g., a distance, a velocity, or an AoA) by transmitting a radar signal s_{RF}(t) including a sequence of chirps and mixing the (delayed) echoes in a received radar signal y_{RF}(t) (after reflection from one or more targets) with a “copy” of the LO signal s_{LO}(t). A baseband signal y(t) resulting from such mixing (e.g., after processing by the baseband signal processing component 110) is illustrated in FIG. 5B. The baseband signal y(t), and therefore the digitized baseband signal y[n] (i.e., a digital radar signal), may be divided into a plurality of segments, where each segment of the digital radar signal y[n] is associated with a particular chirp of the chirp sequence.

Information associated with a given target can then be extracted from a spectrum of segments of the digital radar signal y[n]. A range-velocity map associated with each chirp can be obtained, for example, by performing a two-stage Fourier transformation, as described below. In general, range-velocity maps may be used as a basis for detecting, identifying, and classifying one or more targets. Calculations to generate range-velocity maps can be performed by, for example, the DSP 114, the controller 116, or another hardware or software component of the radar sensor 100.

According to one example, generation of range-velocity maps involves two stages, where a plurality of Fourier transformations are calculated in each stage (e.g., using a fast Fourier transform (FFT) algorithm). For example, the baseband signal y(t) may be sampled such that N×M sampled values (samples); that is to say M segments each containing N samples, are obtained for a chirp sequence containing M chirps. Here, a sampling time interval T_{SAMPLE} is selected such that each of the M segments (i.e., each chirp echo in baseband) is represented by a sequence of N samples. As illustrated in FIG. 5C, the M segments within each set of N samples may be arranged in a two-dimensional array Y[n, m]. Each column of the array Y[n, m] represents one of the M segments under consideration of the baseband signal y(t), and the nth row of the array Y[n, m] contains the nth sample of the M chirps. The row index n (n=0, 1, . . . N−1) may be considered to be a discrete time n·T_{SAMPLE} (within a chirp) on a “fast” time axis. Similarly, the column index m (m=0, 1, . . . . M−1) may be considered to be a discrete time m. T_{CHIRP} on a “slow” time axis. The column index m corresponds to the number of the chirp in the chirp sequence.

In a first stage, a first FFT (sometimes referred to as range FFT) is applied to each chirp. The Fourier transformation is calculated for each column of the array Y[n, m]. In other words, the array Y[n, m] is Fourier-transformed along the fast time axis, and a two-dimensional array R[k, m] of spectra, referred to as range map, is obtained as a result. Here, each of the M columns of the range map includes N (complex-value) spectral values. By virtue of the Fourier transformation, the “fast” time axis becomes the frequency axis; the row index k of the range map R[k, m] corresponds to a discrete frequency and can be referred to as a frequency bin. Each discrete frequency corresponds to a distance according to the above equation, for which reason the frequency axis can also referred to as the distance axis (or the range axis).

An example of a range map R[k, m] is illustrated in FIG. 5C. A radar echo caused by a target results in a local maximum (herein referred to as a peak) at a particular frequency bin/frequency index in the range map R[k, m]. A peak typically appears in all columns of the range map R[k, m]; that is to say the peak typically appears in the spectra of all segments under consideration of the baseband signal y [n] that are associated with the chirps of a chirp sequence. As mentioned above, the associated frequency index k may be converted into a distance value.

In a second stage, a second FFT (sometimes referred to as Doppler FFT) is applied to each of the N rows of the range map R[k, m] (k=0, . . . , N−1). Each row of the range map R[k, m] includes M spectral values of a particular frequency bin, where each frequency bin corresponds to a particular distance d_{T}_{ᵢ} of a particular radar target Tᵢ. The Fourier transformation of the spectral values in a particular frequency bin (able to be associated with a radar target) enables determination of the associated Doppler shift f_{D} that corresponds to a velocity of the target. In other words, the two-dimensional array R[k, m] is Fourier-transformed in rows, that is to say along the “slow” time axis. The resulting Fourier transforms form an array containing N×M spectral values, which is referred to as a range-velocity map X[k, l] (k=0, . . . , N−1 and l=0, . . . , M−1). The “slow” time axis becomes the Doppler frequency axis through the second FFT. The associated discrete Doppler frequency values each correspond to a particular velocity. The Doppler frequency axis may accordingly be converted into a velocity axis. Each peak in the range-velocity map X[k, l] indicates a potential radar target. The row index k (on the range axis) associated with the peak represents the distance of the target, and the column index l (on the velocity axis) associated with the peak represents the velocity of the target. In some implementations, range-velocity maps generated by the radar sensor 100 can be used for gain phase imbalance detection using an LMS technique, as described herein.

As indicated above, FIGS. 5A-5C are provided as examples. Other examples may differ from what is described with regard to FIGS. 5A-5C.

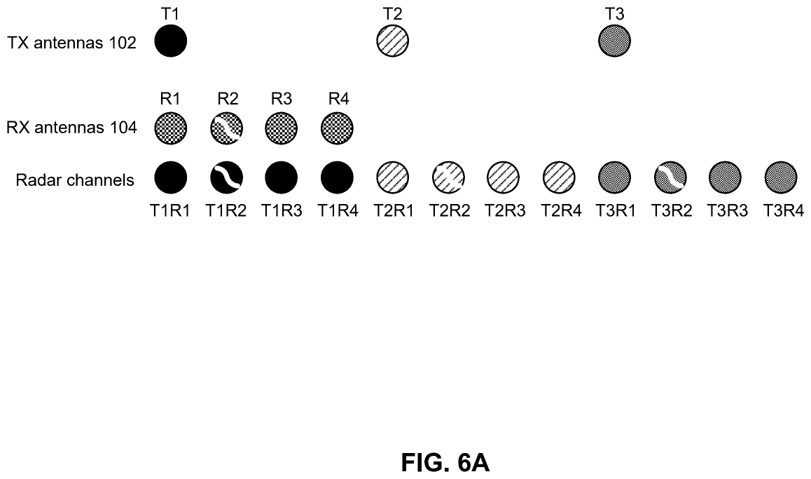

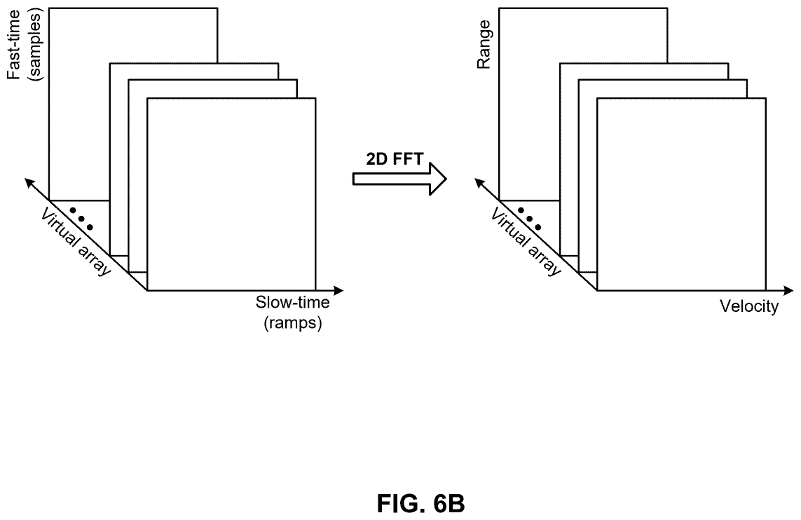

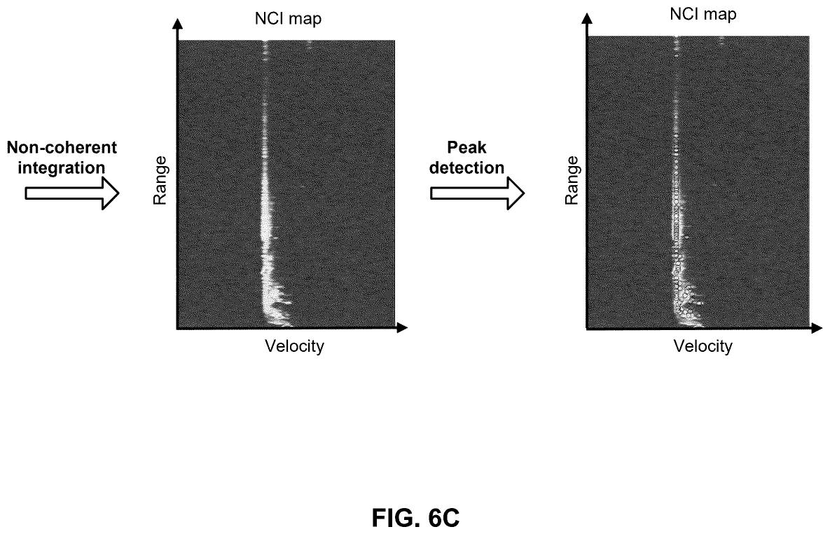

In some implementations, the radar sensor 100 may be configured to detect a phase imbalance of one or more radar channels of the radar sensor 100 using an LMS technique. As used herein, the term radar channel refers to a channel corresponding to a particular combination of TX antenna 102 and RX antenna 104 via which a radar signal is transmitted and received, respectively, by the radar sensor 100. For example, with reference to FIG. 6A, the radar sensor 100 may include three TX antennas 102 T1 through T3 and four RX antennas 104 R1 through R4. Here, as indicated in FIG. 6A, the radar sensor 100 includes 12 radar channels, and each radar channel is associated with a different TX antenna 102/RX antenna 104 combination. As indicated in FIG. 6A, hardware fatigue (e.g., a ball break) on a given antenna (as indicated for RX antenna 104 R2 in FIG. 6), impacts each radar channel associated with the given antenna. For example, with reference to FIG. 6A, radar channels T1R2, T2R2, and T3R2 are impacted by the hardware fatigue on the RX antenna 104 R2.

In some implementations, the radar sensor 100 obtains plurality of range-velocity maps, where each range-velocity map is associated with a respective radar channel from a plurality of radar channels of the radar sensor 100. For example, with reference to FIG. 6B, the radar sensor 100 in some implementations collects data for each radar channel of the plurality of radar channels (e.g., in the manner described above) to form a radar cube defined by the slow-time axis, the fast-time axis, and a virtual array. In FIG. 6B, each element in the virtual array corresponds to a radar channel. For example, with reference to FIG. 6A, a first virtual array element comprises a range-velocity map corresponding to a radar channel T1R1 associated with the TX antenna 102 T1 and the RX antenna 104 R1, a second virtual array element comprises a range-velocity map corresponding to a radar channel T1R2 associated with the TX antenna 102 T1 and the RX antenna 104 R2, and so on. In some implementations, as indicated in FIG. 6B, the radar sensor 100 may perform a two-dimensional FFT on the collected radar data associated with each virtual array element (e.g., as described above with respect to FIGS. 5A-5D) to generate the plurality of range-velocity maps. In this way, the radar sensor 100 may obtain a range-velocity map for each virtual array element (i.e., for each radar channel).

In some implementations, as illustrated in FIG. 6C, the radar sensor 100 may generate an integrated range-velocity map based on the plurality of range-velocity maps. For example, the radar sensor 100 may combine data from the plurality of range-velocity maps to generate the integrated range-velocity map. In some implementations, the radar sensor 100 may perform a non-coherent integration of the plurality of range-velocity maps to generate the integrated range-velocity map. Thus, in some implementations, the integrated range-velocity map may be a non-coherent integration (NCI) map.

As indicated above, FIGS. 6A-6C are provided as examples. Other examples may differ from what is described with regard to FIGS. 6A-6C.

Peaks (i.e., local maximums) of the integrated range-velocity map represent one or more targets in a corresponding range-velocity bin. In some implementations, the radar sensor 100 may identify a peak in the integrated range-velocity map by determining whether a value in a given range-velocity bin of the integrated range-velocity map satisfies (e.g., is greater than or equal to) a peak detection threshold. In some implementations, each peak is associated with a range-velocity bin index that corresponds to a range-velocity bin in which the peak is detected.

In some implementations, after identifying a peak in the integrated range-velocity map, the radar sensor 100 may extract a data set from the plurality of range-velocity maps associated with the peak. For example, the radar sensor 100 may extract, from each range-velocity map of the plurality of range-velocity maps, data that is included in a respective range-velocity bin associated with the range-velocity bin index in which the peak was identified. Here, the data set includes data from the identified range-velocity bin index for each virtual array element. The data set includes data indicating the AoA (i.e., angle) of one or more targets, amplitude imbalances of the radar channels, and phase imbalances of the radar channels. The data set is a signal vector along the virtual array axis of the radar cube that is addressed by the fast-time index and slow-time index of the identified peak.

The extracted signal vector can be modeled as:

$$s [ k ] = {r}_{i m b} [ k ] {e}^{j {φ}_{i m b} [ k ]} {\sum }_{i = 1}^{Q} {α}_{i} {e}^{j ( 2 π {f}_{{θ}_{i}} k + {φ}_{i} )} + n [ k ] \qquad ( 1 )$$

where k=1: K is an index of virtual array elements, Q is the number of targets in the corresponding range-velocity bin, and α_{q}, f_{θq}, and δ_{q} are the amplitude, frequency, and constant phase, respectively, corresponding to the qth target. n[k] represents an additive white Gaussian noise on the signal vector s, and r_{imb}[k] and φ_{imb}[k] are the gain and phase offsets, respectively, caused by production variations, temperature drifts, hardware fatigue, or the like.

Equation (1) can be rewritten in a compact form as:

$$s = diag ( x ) ψ + n \qquad ( 2 )$$

where diag(·) gives a diagonal matrix of the input vector, and vectors y=[ψ[1], . . . , ψ[K]] T and x=[x[1], . . . , x[K]] T are defined as:

$$ψ [ k ] = r [ k ] {e}^{{j}_{φ} [ k ]} , and \qquad ( 3 )$$

$$x [ k ] = {\sum }_{q = 1}^{Q} {α}_{q} {e}^{j ( 2 π {f}_{{θ}_{q}} k + {δ}_{q} )} ,$$

representing effects of the MMIC 106 (e.g., gain and phase offsets) and the effects of the environment, respectively. In some implementations, the vector ψ is assumed to include no linear phase progression. In other words, the vector ψ is assumed to have no linear trend.

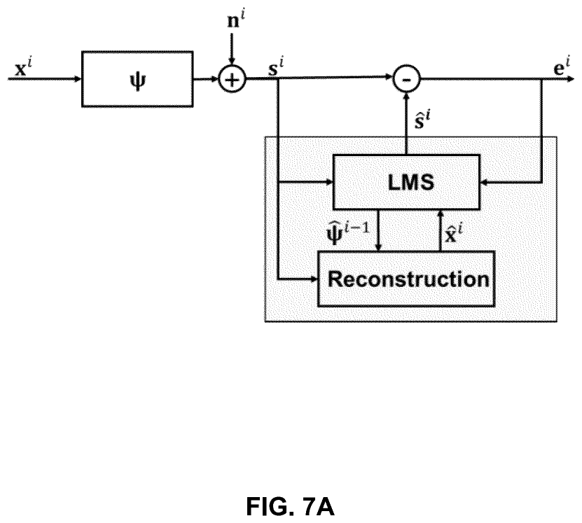

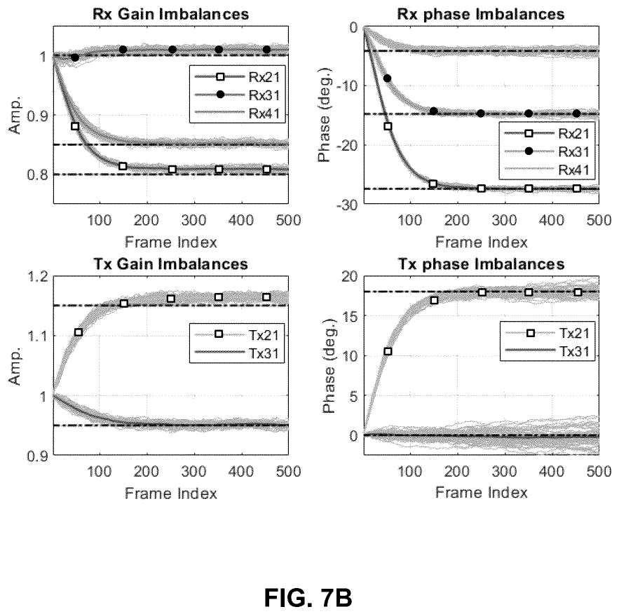

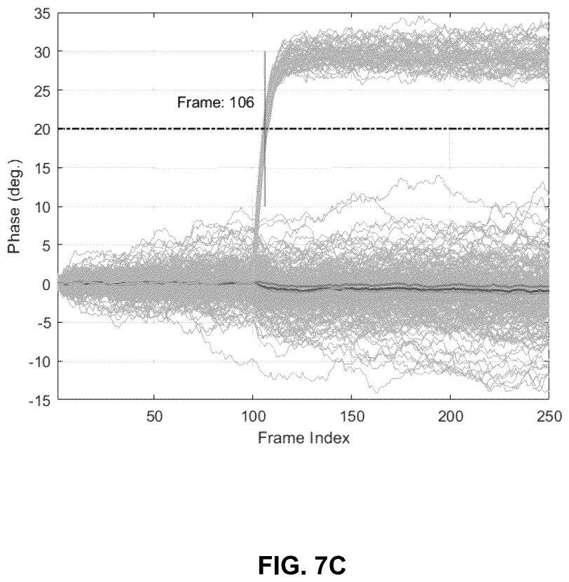

Equation (2) can be interpreted as a model for K single-tap filters with an input signal x (herein referred to as a target signal vector), an output s (herein referred to as an actual signal vector), and filter coefficients of ψ (herein referred to as an imbalance vector). In some implementations, estimation of the imbalance vector ψ can be iteratively performed using an adaptive signal processing technique, such as a normalized least mean squares (NLMS) technique. According to the conventional (normalized) LMS technique, the input signal x is known. However, with respect to operation of the radar sensor 100, only a filtered version of the input signal x is known. That is, the actual signal vector s (i.e., a signal vector after the effects of the imbalance and noise) is known, but the target signal vector x is unknown. In some implementations, a cyclic approach can be used to estimate the (unknown) imbalance vector ψ and the unknown target signal vector x in a given iteration. In some implementations, the cyclic approach uses a loop that executes two steps in a given iteration. In a first step, for a given iteration i, an estimated target signal vector \hat{x} is determined (e.g., estimated, reconstructed, computed, or the like) based on the actual signal vector s and an estimated imbalance vector \hat{ψ} associated with a previous iteration (i.e., estimated imbalance vector \hat{ψ}ⁱ⁻¹). In a second step, the estimated imbalance vector \hat{ψ} is updated using the normalized LMS technique and the estimated target signal vector target signal vector \hat{x}. FIG. 7A illustrates a block diagram of the cyclic approach, with i representing an iteration index. Additional details regarding the steps of the cyclic approach are described below.

As described above, in a first step of an iteration i associated with performing gain and phase imbalance estimation, the radar sensor 100 (e.g., the controller 116) may determine an estimated target signal vector \hat{x} based on the actual signal vector s and an estimated imbalance vector \hat{ψ}ⁱ⁻¹ (i.e., a first estimated imbalance vector, an estimated imbalance vector associated with a previous iteration i−1). In this step, a portion of the actual signal vector s that corresponds to reflections from targets in the environment of the radar sensor 100 is estimated. In some implementations, to determine the estimated target signal vector \hat{x}, the radar sensor 100 may calibrate the actual signal vector s based on an inverse of the estimated imbalance vector \hat{ψ}ⁱ⁻¹ to determine a calibrated signal vector x′. The inverse of the estimated imbalance vector \hat{ψ}ⁱ⁻¹ is cⁱ=1Ø\hat{ψ}ⁱ⁻¹, where Ø is the elementwise division. In some implementations, the calibration is used to mitigate the effect of gain and phase offsets at iteration i. A vector resulting from the calibration is:

$${x}^{′} = {c}^{i} ⊙ {s}^{i} \qquad ( 4 )$$

$${x}^{′} = {c}^{i} ⊙ ψ ⊙ {x}^{i} + {c}^{i} ⊙ {n}^{i}$$

$${x}^{′} = {n}_{m} ⊙ {x}^{i} + {n}_{a}$$

where ⊙ denotes the elementwise multiplication, nₘ=cⁱ⊙ψⁱ and nₐ=cⁱ⊙nⁱ are multiplicative and additive noise vectors, respectively, and for the first iteration, cⁱ⁼¹=1. Next, the radar sensor may perform a parameter estimation based on the calibrated signal vector x′ to determine the estimated target signal vector \hat{x}. In some implementations, the radar sensor 100 may perform the parameter estimation using an FFT-based iterative technique, such as the CLEAN method, which provides high parameter estimation accuracy. Using the CLEAN method, with the calibrated signal vector x′ as an input, a number of the peaks \hat{Q}, amplitudes \hat{α}_{q}, phases \hat{δ}_{q}, and locations \hat{f}_{θq} of peaks are estimated for q=1, . . . \hat{Q}. Thus, at each iteration i, the target signal vector x can be reconstructed as the estimated target signal vector \hat{x}, where:

$$\hat{x} [ k ] = {\sum }_{q = 1}^{Q} {\hat{α}}_{q} {e}^{j ( 2 π {\hat{f}}_{{θ}_{q}} k + {\hat{δ}}_{q} )} \qquad ( 5 )$$

In some implementations, the radar sensor 100 may perform the parameter estimation using an FFT-based iterative technique, such as the CLEAN method as noted above. In some implementations, the radar sensor 100 may perform the parameter estimation using another technique, such as a relaxation algorithm for non-linear least squares AoA estimation (e.g., the relax method, which is an extension of the CLEAN method comprising additional rounds of estimation), a multiple signal classification (MUSIC) algorithm in combination with an order (i.e., number of targets) estimation method (e.g., a generalized likelihood ratio test (GLRT)), or another parameter estimation technique.

As described above, in a second step of the iteration i associated with performing gain and phase imbalance estimation, the radar sensor 100 (e.g., the controller 116) may determine an updated estimated imbalance vector \hat{ψ} (i.e., a second estimated imbalance vector, an estimated imbalance vector associated with the current iteration i). In some implementations, the radar sensor 100 determines the updated estimated imbalance vector \hat{ψ} based on the actual signal vector s, the estimated target signal vector R, and an error vector e (e.g., an error signal corresponding to a difference between the actual signal vector s and an estimated actual signal vector s that is determined based on the estimated imbalance vector \hat{ψ}). In some implementations, the radar sensor 100 determines the updated estimated imbalance vector \hat{ψ} using an LMS technique. In some implementations, in association with using the LMS technique (e.g., normalized LMS), a squared instantaneous error is considered as the cost function:

$${J}^{i} [ k ] = {( {e [ k ]}^{i} )}^{2} = {( {s}^{i} [ k ] - {\hat{ψ}}^{i} [ k ] {\hat{x}}^{i} [ k ] )}^{2} \qquad ( 6 )$$

for each element k, and in vector form as:

$${J}^{i} = {( {e}^{i} )}^{2} = {( {s}^{i} - diag ( {\hat{x}}^{i} ) {\hat{ψ}}^{i} )}^{2} \qquad ( 7 )$$

The update equations for this cost function can be written as:

$${μ}^{i} = {μ}_{0} / [ {( {\hat{x}}^{i} )}^{H} {\hat{x}}^{i} + ϵ ] \qquad ( 8 )$$

$$∇ {J}^{i} = {diag ( {\hat{x}}^{i} )}^{H} ( {s}^{i} - diag ( {\hat{x}}^{i} ) {\hat{ψ}}^{i} )$$

$${\hat{ψ}}^{i} = {\hat{ψ}}^{i - 1} - {μ}^{i} ∇ {J}^{i}$$

where μⁱ is a normalized step size, μ₀ and ∈ are constant values, and ∇Jⁱ is a gradient of the cost function Jⁱ.

In some implementations, the radar sensor 100 (e.g., the controller 116) may perform an action, associated with the plurality of radar channels, based on the estimated imbalance vector \hat{ψ}. For example, the action performed by the radar sensor 100 may include performing an imbalance calibration, associated with the plurality of radar channels of the radar sensor 100, based on the estimated imbalance vector \hat{ψ}. That is, the radar sensor 100 can use the estimated imbalance vector \hat{ψ} to calibrate the virtual array to correct for gain or phase imbalances among the radar channels, a result of which is a calibrated signal that can be used for AoA estimation with improved accuracy and reliability.

As another example, the action performed by the radar sensor 100 may include performing a fatigue detection procedure. For example, the radar sensor 100 may determine a phase imbalance associated with a radar channel from the plurality of radar channels based on the estimated imbalance vector \hat{ψ}. Here, the radar sensor 100 may derive gain and phase offsets of the radar channels by averaging over the corresponding elements of the estimated imbalance vector \hat{ψ} to the same RX and TX channels. The resulting values are then divided by a particular element (e.g., the first element) to estimate channel imbalances of RX and TX relative to the particular (first) channel. The radar sensor 100 may then detect whether the phase imbalance associated with a given radar channel satisfies a detection threshold (e.g., a threshold that, if satisfied, would be indicative of an occurrence of hardware fatigue such as a ball break, a signal line issue, an antenna feed issue, or the like). Here, if the radar sensor 100 determines that the phase imbalance associated with the radar channel satisfies (e.g., is greater than or equal to) the detection threshold, then the radar sensor 100 may determine that the radar channel is experiencing a fatigue-related issue (e.g., a ball break, a signal line issue, an antenna feed issue, or the like). Conversely, if the radar sensor 100 determines that the phase imbalance associated with the radar channel does not satisfy (e.g., is less than) the detection threshold, then the radar sensor 100 may determine that the radar channel is not experiencing a fatigue-related issue.

In some implementations, the action performed by the radar sensor 100 may include gain or phase monitoring associated with a set of TX antennas of the radar sensor 100 and a set of RX antennas of the radar sensor 100. That is, according to the techniques and apparatuses described herein, the radar sensor 100 can perform gain or phase monitoring on both the TX channels and the RX channels of the radar sensor 100.

Notably, the operations performed by the radar sensor 100 (e.g., the extraction of the actual signal vector s, the determination of the estimated target signal vector x, the determination of the estimated imbalance vector \hat{ψ}, and the performance of the action) can be executed irrespective of a quantity of targets indicated by the peak in the integrated range-velocity map. That is, the operations described above can be performed regardless of the quantity of targets indicated by the peak (i.e., a peak indicating only a single target is not necessary).

The radar sensor 100 may perform further iterations of the process described with respect to FIG. 7A in association with performing gain and phase imbalance using the LMS technique (e.g., during normal operation of the radar sensor 100).

An example radar sensor 100 comprises three TX antennas (e.g., TX antenna 102 T1, TX antenna 102 T2, and TX antenna 102 T3) and four RX antennas (e.g., RX antenna 104 R1, RX antenna 104 R2, RX antenna 104 R3, and RX antenna 104 R4), forming 12 radar channels (K=12) (e.g., as shown in FIG. 6A). In one example, 500 radar frames, each containing 10 peaks in a range-doppler map, are considered, and signal vectors on each peak with random parameters and a signal-to-noise ratio (SNR) of 20 decibels (dB) are generated according to Equation (1).

FIG. 7B is shows average convergence behavior of the techniques and apparatuses described herein over the radar frames for TX channels and RX channels over 100 Monte Carlo runs. Here, the constant value of the learning rate is set to 0.05 (e.g., μ₀=0.05). In FIG. 7B, imbalances of a given TX channel are shown relative to a TX channel of the first TX antenna 102 T1 and imbalances of a given RX channel are shown relative to an RX channel of the first RX antenna 104 R1. Lighter gray curves in FIG. 7B represent the Monte Carlo runs, and dark curves illustrate average values of the Monte Carlo runs associated with a given channel.

Dashed lines show injected imbalances. Gain and phase imbalance correction is provided for the TX and RX channels in the manner described above with respect to FIG. 7A. As shown in FIG. 7B, and considering a frame rate of 20 frames per second, the imbalance calibration is achieved in approximately 10 seconds for a given channel.

FIG. 7C illustrates an example of performance of the radar sensor 100 with respect to ball break detection. In this example, a ball break is assumed on an RX channel associated with an RX antenna 104 R3 at 100 by injecting a 30 degree) (° phase offset at the RX channel at frame 100. Lighter gray curves in FIG. 7C represent the Monte Carlo estimations, while darker curves illustrate average values of the Monte Carlo runs associated with a given channel. A dashed line shows a detection threshold for detecting a ball break, which in this example is set to 20°. With the constant value of the learning rate set to 0.45 (e.g., μ₀=0.45), the radar sensor 100 detects the ball break within approximately seven radar frames of the occurrence of the ball break (e.g., the radar sensor 100 detects the ball break at frame 106). As illustrated in FIG. 7C, the techniques and apparatuses described herein can provide fast ball break detection, thereby ensuring safe and reliable operation of the radar sensor 100 with respect to ball break detection.

The radar sensor 100 described herein provides the following advantages (e.g., as compared to the prior techniques described above): (1) the radar sensor 100 can perform gain and phase imbalance detection and calibration using the LMS technique nearly independent of scenario because the radar sensor 100 allows for multiple targets in a range-Doppler bin associated with a peak, thereby providing faster gain and phase imbalance estimation calibration and ball break detection; (2) the radar sensor 100 provides gain and phase estimation and calibration on both the TX and RX sides of the radar sensor 100; (3) the LMS technique implemented on the radar sensor 100 does not adversely impact performance of the radar (e.g., as compared to hardware-based solutions); and (4) the LMS technique is implemented at the system level, meaning that no area of the MMIC is needed to perform gain and phase imbalance estimation.

As indicated above, FIGS. 7A-7C are provided as examples. Other examples may differ from what is described with regard to FIGS. 7A-7C.

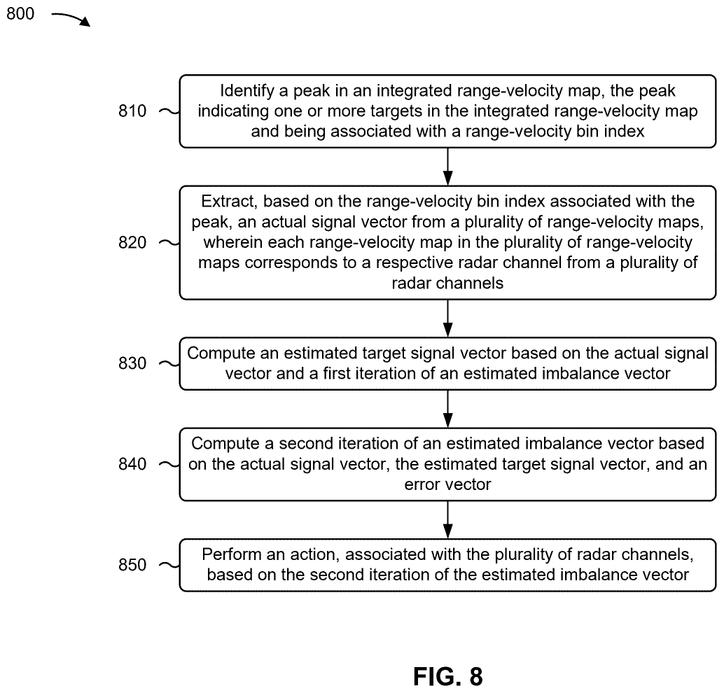

FIG. 8 is a flowchart of an example process 800 associated with gain and phase imbalance estimation. In some implementations, one or more process blocks of FIG. 8 are performed by a radar sensor (e.g., radar sensor 100) or one or more components of the radar sensor (e.g., the MMIC 106, the DSP 114, the controller 116, or the like).

As shown in FIG. 8, process 800 may include identifying a peak in an integrated range-velocity map, the peak indicating one or more targets in the integrated range-velocity map and being associated with a range-velocity bin index (block 810). For example, the radar sensor may identify a peak in an integrated range-velocity map, the peak indicating one or more targets in the integrated range-velocity map and being associated with a range-velocity bin index, as described above.

As further shown in FIG. 8, process 800 may include extracting, based on the range-velocity bin index associated with the peak, an actual signal vector from a plurality of range-velocity maps, wherein each range-velocity map in the plurality of range-velocity maps corresponds to a respective radar channel from a plurality of radar channels (block 820). For example, the radar sensor may extract, based on the range-velocity bin index associated with the peak, an actual signal vector from a plurality of range-velocity maps, wherein each range-velocity map in the plurality of range-velocity maps corresponds to a respective radar channel from a plurality of radar channels, as described above.

As further shown in FIG. 8, process 800 may include computing an estimated target signal vector based on the actual signal vector and a first iteration of an estimated imbalance vector (block 830). For example, the radar sensor may compute an estimated target signal vector based on the actual signal vector and a first iteration of an estimated imbalance vector, as described above.

As further shown in FIG. 8, process 800 may include computing a second iteration of an estimated imbalance vector based on the actual signal vector, the estimated target signal vector, and an error vector (block 840). For example, the radar sensor may compute a second iteration of an estimated imbalance vector based on the actual signal vector, the estimated target signal vector, and an error vector, as described above.

As further shown in FIG. 8, process 800 may include performing an action, associated with the plurality of radar channels, based on the second iteration of the estimated imbalance vector (block 850). For example, the radar sensor may perform an action, associated with the plurality of radar channels, based on the second iteration of the estimated imbalance vector, as described above.

Process 800 may include additional implementations, such as any single implementation or any combination of implementations described below and/or in connection with one or more other processes described elsewhere herein.

In a first implementation, computing the estimated target signal vector comprises calibrating the actual signal vector based on an inverse of the first iteration of the estimated imbalance vector to determine a calibrated signal vector, and performing a parameter estimation based on the calibrated signal vector to determine the estimated target signal vector.

In a second implementation, alone or in combination with the first implementation, the second iteration of the estimated imbalance vector is computed using an LMS technique.

In a third implementation, alone or in combination with one or more of the first and second implementations, performing the action comprises calibrating for a gain or phase imbalance, associated with the plurality of radar channels, based on the second iteration of the estimated imbalance vector.

In a fourth implementation, alone or in combination with one or more of the first through third implementations, performing the action comprises determining a phase imbalance associated with a radar channel from the plurality of radar channels based on the second iteration of the estimated imbalance vector, and detecting whether the phase imbalance associated with the radar channel satisfies a detection threshold.

In a fifth implementation, alone or in combination with one or more of the first through fourth implementations, the action comprises gain or phase monitoring associated with a set of transmit antennas of a radar device and a set of receive antennas of the radar device.

In a sixth implementation, alone or in combination with one or more of the first through fifth implementations, extracting the actual signal vector, computing the estimated target signal vector, computing the second iteration of the estimated imbalance vector, and performing the action are executed irrespective of a quantity of targets indicated by the peak.

Although FIG. 8 shows example blocks of process 800, in some implementations, process 800 includes additional blocks, fewer blocks, different blocks, or differently arranged blocks than those depicted in FIG. 8. Additionally, or alternatively, two or more of the blocks of process 800 may be performed in parallel.

The foregoing disclosure provides illustration and description, but is not intended to be exhaustive or to limit the implementations to the precise forms disclosed. Modifications and variations may be made in light of the above disclosure or may be acquired from practice of the implementations.

As used herein, the term “component” is intended to be broadly construed as hardware, firmware, and/or a combination of hardware and software. It will be apparent that systems and/or methods described herein may be implemented in different forms of hardware, firmware, or a combination of hardware and software. The actual specialized control hardware or software code used to implement these systems and/or methods is not limiting of the implementations. Thus, the operation and behavior of the systems and/or methods are described herein without reference to specific software code—it being understood that software and hardware can be designed to implement the systems and/or methods based on the description herein.

As used herein, satisfying a threshold may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of various implementations. In fact, many of these features may be combined in ways not specifically recited in the claims and/or disclosed in the specification. Although each dependent claim listed below may directly depend on only one claim, the disclosure of various implementations includes each dependent claim in combination with every other claim in the claim set. As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiple of the same item.

When “a component” or “one or more components” (or another element, such as “a controller” or “one or more controllers”) is described or claimed (within a single claim or across multiple claims) as performing multiple operations or being configured to perform multiple operations, this language is intended to broadly cover a variety of architectures and environments. For example, unless explicitly claimed otherwise (e.g., via the use of “first component” and “second component” or other language that differentiates components in the claims), this language is intended to cover a single component performing or being configured to perform all of the operations, a group of components collectively performing or being configured to perform all of the operations, a first component performing or being configured to perform a first operation and a second component performing or being configured to perform a second operation, or any combination of components performing or being configured to perform the operations. For example, when a claim has the form “one or more components configured to: perform X; perform Y; and perform Z,” that claim should be interpreted to mean “one or more components configured to perform X; one or more (possibly different) components configured to perform Y; and one or more (also possibly different) components configured to perform Z.”

No element, act, or instruction used herein should be construed as critical or essential unless explicitly described as such. Also, as used herein, the articles “a” and “an” are intended to include one or more items, and may be used interchangeably with “one or more.” Further, as used herein, the article “the” is intended to include one or more items referenced in connection with the article “the” and may be used interchangeably with “the one or more.” Furthermore, as used herein, the term “set” is intended to include one or more items (e.g., related items, unrelated items, or a combination of related and unrelated items,), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. A radar device, comprising:
one or more memories; and
one or more processors, communicatively coupled to the one or more memories, configured to:
identify a peak in an integrated range-velocity map, the peak indicating one or more targets in the integrated range-velocity map and being associated with a range-velocity bin index;
extract, based on the range-velocity bin index associated with the peak, an actual signal vector from a plurality of range-velocity maps, wherein each range-velocity map in the plurality of range-velocity maps corresponds to a respective radar channel from a plurality of radar channels;
determine an estimated target signal vector based on the actual signal vector and a first estimated imbalance vector;
determine a second estimated imbalance vector based on the actual signal vector, the estimated target signal vector, and an error vector; and
perform an action, associated with the plurality of radar channels, based on the second estimated imbalance vector.

2. The radar device of claim 1, wherein the one or more processors, to determine the estimated target signal vector, are configured to:
calibrate the actual signal vector based on an inverse of the first estimated imbalance vector to determine a calibrated signal vector; and
perform a parameter estimation based on the calibrated signal vector to determine the estimated target signal vector.

3. The radar device of claim 2, wherein the parameter estimation is performed using a fast-Fourier transform (FFT) based iterative technique.

4. The radar device of claim 1, wherein the second estimated imbalance vector is determined using a least mean squares (LMS) technique.

5. The radar device of claim 1, wherein the one or more processors, to perform the action, are configured to perform an imbalance calibration, associated with the plurality of radar channels, based on the second estimated imbalance vector.

6. The radar device of claim 1, wherein the one or more processors, to perform the action, are configured to:
determine a phase imbalance associated with a radar channel from the plurality of radar channels based on the second estimated imbalance vector; and
detect whether the phase imbalance associated with the radar channel satisfies a detection threshold.

7. The radar device of claim 1, wherein the action comprises gain or phase monitoring associated with a set of transmit antennas of the radar device and a set of receive antennas of the radar device.

8. The radar device of claim 1, wherein the extraction of the actual signal vector, the determination of the estimated target signal vector, the determination of the second estimated imbalance vector, and the performance of the action are executed irrespective of a quantity of targets indicated by the peak.

9. A method, comprising:
identifying a peak in an integrated range-velocity map, the peak indicating one or more targets in the integrated range-velocity map and being associated with a range-velocity bin index;
extracting, based on the range-velocity bin index associated with the peak, an actual signal vector from a plurality of range-velocity maps, wherein each range-velocity map in the plurality of range-velocity maps corresponds to a respective radar channel from a plurality of radar channels;
computing an estimated target signal vector based on the actual signal vector and a first iteration of an estimated imbalance vector;
computing a second iteration of an estimated imbalance vector based on the actual signal vector, the estimated target signal vector, and an error vector; and
performing an action, associated with the plurality of radar channels, based on the second iteration of the estimated imbalance vector.

10. The method of claim 9, wherein computing the estimated target signal vector comprises:
calibrating the actual signal vector based on an inverse of the first iteration of the estimated imbalance vector to determine a calibrated signal vector; and
performing a parameter estimation based on the calibrated signal vector to determine the estimated target signal vector.

11. The method of claim 9, wherein the second iteration of the estimated imbalance vector is computed using a least mean squares (LMS) technique.

12. The method of claim 9, wherein performing the action comprises calibrating for a gain or phase imbalance, associated with the plurality of radar channels, based on the second iteration of the estimated imbalance vector.

13. The method of claim 9, wherein performing the action comprises:
determining a phase imbalance associated with a radar channel from the plurality of radar channels based on the second iteration of the estimated imbalance vector; and
detecting whether the phase imbalance associated with the radar channel satisfies a detection threshold.

14. The method of claim 9, wherein the action comprises gain or phase monitoring associated with a set of transmit antennas of a radar device and a set of receive antennas of the radar device.

15. The method of claim 9, wherein extracting the actual signal vector, computing the estimated target signal vector, computing the second iteration of the estimated imbalance vector, and performing the action are executed irrespective of a quantity of targets indicated by the peak.

16. A radar device, comprising:
one or more memories; and
one or more processors, communicatively coupled to the one or more memories, configured to:
compute an estimated target signal vector based on an actual signal vector and a first estimate of an imbalance vector associated with a plurality of radar channels;
compute a second estimate of the imbalance vector based on the actual signal vector, the estimated target signal vector, and an error vector; and
perform an action based on the second estimate of the imbalance vector, wherein the action is associated with at least one of phase imbalance calibration for the plurality of radar channels or fatigue detection from the plurality of radar channels.

17. The radar device of claim 16, wherein the one or more processors, to compute the estimated target signal vector, are configured to:
calibrate the actual signal vector based on an inverse of the first estimate of the imbalance vector to determine a calibrated signal vector; and
perform a parameter estimation based on the calibrated signal vector to determine the estimated target signal vector.

18. The radar device of claim 16, wherein the second estimate of the imbalance vector is determined using a least mean squares (LMS) technique.

19. The radar device of claim 16 wherein the action comprises gain or phase monitoring associated with a set of transmit antennas of the radar device and a set of receive antennas of the radar device.

20. The radar device of claim 16, wherein the computation of the estimated target signal vector, the computation of the second estimate of the imbalance vector, and the performance of the action are executed irrespective of a quantity of targets indicated by a peak associated with the actual signal vector.
